(19) United States
(12) Patent Application Publication
(10) Pub. No.: US 2010/0136359 A1
(43) Pub. Date: Jun. 3, 2010

(54) COATING COMPOSITIONS COMPRISING BISMUTH-ALLOYED ZINC

(75) Inventors: Claus Erik Weinell, Birkerod (DK); Jeroen Van Den Bosch, Olen (BE); Pascal Verbiest, Olen (BE); Hellen Fiedler, Virum (DK); Torben Schandel, Birkerod (DK); Gert Simonsen, Espergaerde (DK)

Correspondence Address: BIRCH STEWART KOLASCH & BIRCH, PO BOX 747, FALLS CHURCH, VA, 22040-0747, US

(73) Assignees: Hempel A/S, Lyngby (DK); UMICORE, Brussels (BE)

(21) Appl. No.: 12/595,043

(22) PCT Filed: Apr. 11, 2008
(86) PCT No.: PCT/EP2008/054399

§ 371 Date: Jan. 19, 2010

(30) Foreign Application Priority Data
Apr. 12, 2007 (EP) 07106030.5

(51) Int. Cl. B32B 15/02

(52) U.S. Cl. 428/553; 524/440; 420/513; 420/514; 420/523; 420/524

(57) ABSTRACT

The present application discloses (i) a coating composition comprising a particulate zinc-based alloyed material, said material comprising 0.05-0.7% by weight of bismuth (Bi), the D₅₀ of the particulate material being in the range of 2.5-30 μm; (ii) a coated structure comprising a metal structure having a first coating of the zinc-containing coating composition applied onto at least a part of the metal structure in a dry film thickness of 5-100 μm; and an outer coating applied onto said zinc-containing coating in a dry film thickness of 30-200 μm; (iii) a particulate zinc-based alloyed material, wherein the material comprises 0.05-0.7% (w/w) of bismuth (Bi), and wherein the D₅₀ of the particulate material is in the range of 2.5-30 μm; (iv) a composite powder consisting of at least 25% (w/w) of the particulate zinc-based alloyed material, the rest being a particulate material consisting of zinc and unavoidable impurities; and (v) a composite powder consisting of the particulate zinc-based alloyed material and up to 30% (w/w) of one or more additives.

### FIELD OF THE INVENTION

The present invention resides in the field of anti-corrosive coating composition, in particular coating compositions for protecting iron and steel structures. In particular, the present invention relates to coating compositions comprising a particulate zinc-based alloyed material comprising bismuth. Further, the invention relates to particulate zinc-based alloyed materials comprising bismuth, and to composite powders consisting of the particulate zinc-based alloyed material and additives.

### BACKGROUND OF THE INVENTION

Zinc rich primers, both organic and in-organic coatings, are extensively used in the marine and offshore industry and may also be specified for e.g. bridges, containers, refineries, petrochemical industry, power-plants, storage tanks, cranes, windmills and steel structures part of civil structures e.g. airports, stadia, tall buildings. Such coatings may be based on a number of binder systems, such as binder systems based on silicates, epoxy, polyurethanes, cyclic rubber, phenoxy resin, etc.

In zinc primers, zinc is used as a pigment to produce an anodically active coating. Zinc acts as sacrificial anodic material and protect the steel substrate which becomes the cathode. The resistance to corrosion is dependent on the transfer of galvanic current by the zinc primer but as long as the conductivity in the system is preserved and as long there is sufficient zinc to act as anode the steel will be protected galvanically. Therefore zinc pigment particles in zinc epoxies are packed closely together and zinc epoxies are typically formulated with very high loadings of zinc powder. Zinc loadings of up to 95% by weight in dry film have been used.

The beneficial effect of zinc-rich primer on the durability of protective organic coatings is primarily assumed to be due to a cathodic protection mechanism. During the 60's and the 70's zinc rich epoxy primers dominated the market. Later, zinc ethyl silicate primers took over this role due to these products superior anticorrosive properties. However zinc silicate primers have some drawbacks compared to zinc epoxies. Zinc silicates are demanding in terms of curing conditions (epoxies will cure faster and they are not dependent on high humidity), they are difficult to overcoat (the porosity of silicates may cause popping) and they are more demanding in terms of substrate preparation prior to application, in other words they are less surface tolerant. Additionally, zinc silicates will typically have a higher VOC than epoxies. For these reasons it would be very advantageous if a zinc epoxy primer was available having anticorrosive properties similar to those of a zinc silicate. Such zinc epoxy primers would be very attractive for maintenance use and for new buildings where surface preparation requirements cannot be met, applicators are less skilled and/or where climate control during application does not favour zinc-silicates (Taekker, N., Rasmussen, S, N. and Roll, J. Offshore coating maintenance—Cost affect by choice of new building specification and ability of the applicator, NACE International, paper no. 06029 (2006)).

In order to establish sufficient corrosion protection and ensure optimum performance of the coating, it is necessary to specify the requirements for the protection paint system along with the relevant laboratory performance tests to assess its likely durability. The use of new technologies and paint formulations also means coatings being developed with little or no previous track record. This has resulted in more emphasis being placed on accelerated laboratory testing to evaluate coating performance. Many of these accelerated exposure tests will not, within their exposure time show the negative effects visually on intact coated surfaces. Therefore behaviour of the coatings around artificially made damages i.e. scores are given significant considerations, and many prequalification tests are based amongst others on rust creep and blistering as well as detachment from scores, NORSOK M-501, ISO 20340, NACE TM 0104, 0204, 0304, 0404, etc. (Weinell, C. E. and S, N. Rasmussen, Advancement in zinc rich epoxy primers for corrosion protection, NACE International, paper no. 07007 (2007)). These accelerated weathering methods seek to intensify the effects from the environment so that the film breakdown occurs more rapidly (Mitchell, M. J., Progress in offshore coatings, NACE International, paper no. 04001 (2004)). The lower the rust creep the better overall anticorrosive performance.

EP 661766 discloses a zinc powder for use in battery cells. It is mentioned that powder may additionally be used as an anti-corrosive pigment in paints. The zinc powder has at least one corrosion inhibitor metal intrinsically alloyed therein. The corrosion inhibitor metal is, e.g., a mixture of indium and bismuth.

JP 09-268265 discloses a coating composition comprising a zinc-aluminium alloy including one or more further elements in a total amount of 0.005-10% by weight.

WO 2004/021483 discloses bismuth-indium alloyed zinc powders for use in electrolytic cells.

U.S. Pat. No. 6,436,539 discloses a corrosion resistant zinc alloy powder comprising lead, indium, bismuth and/or gallium.

U.S. Pat. No. 3,998,771 discloses water-based epoxy resin zinc-rich coating compositions.

### SUMMARY OF THE INVENTION

The present invention solves the above problems by means of a coating composition which provides significantly lower rust creep than traditional coatings (e.g. zinc epoxy products), and by means of a particulate bismuth-containing zinc-based alloyed material (in particular a bismuth-alloyed zinc powder) which is useful for significantly reducing the rust creep when used in zinc-containing coatings.

More particular, the present invention provides a coating composition comprising a particulate zinc-based alloyed material, wherein said material comprises 0.05-0.7% by weight of bismuth (Bi), the D₅₀ of the particulate material being in the range of 2.5-30 μm, in particular 2.5-20 μm. A coating prepared from this composition has a significantly lower rust creep than conventional zinc-containing coating.

The present invention also provides a coated structure comprising a metal structure having a first coating of the zinc-containing coating composition defined herein applied onto at least a part of the metal structure in a dry film thickness of 5-100 μm; and optionally an intermediate coating applied onto said zinc-containing coating in a dry film thickness of 50-200 μm, and an outer coating applied onto said intermediate coating in a dry film thickness of 30-200 μm.

Furthermore the present invention provides a particulate zinc-based alloyed material, wherein the material comprises 0.05-0.7% by weight of bismuth (Bi), and wherein the D₅₀ of the particulate material is in the range of 2.5-30 μm, in particular 2.5-20 μm, which is useful for significantly reducing the rust creep when used in zinc-containing coating compositions.

Moreover, the present invention provides a composite powder consisting of the particulate zinc-based alloyed material and up to 30% by weight of one or more additives.

### DETAILED DESCRIPTION OF THE INVENTION

### Coating Composition

As mentioned above, the aspect of the present invention relates to a coating composition comprising a particulate zinc-based alloyed material, said material comprising 0.05-0.7% by weight of bismuth (Bi), the D₅₀ of the particulate material being in the range of 2.5-30 μm, in particular 2.5-20 μm.

The compositions defined herein are particularly useful as coating compositions due to their excellent anti-corrosive properties. As it will be understood for the present description, the particulate zinc-based alloyed material is typically used in combination with conventional binder systems in a similar manner as zinc powder is used in conventional zinc-rich, anti-corrosive coating systems.

In the most practical embodiments, the coating composition comprises a binder system selected from epoxy-based binder systems, silicate-based binder systems, polyurethane-based binder systems, cyclic rubber-based binder systems, and phenoxy resin-based binder systems.

Preferably, the binder system of the present invention is selected from an epoxy-based binder system and a silicate-based binder system. Of particular interest are the compositions where the binder system is an epoxy-based binder system. Theses embodiments will be explained in more details further below.

### The Particulate Bismuth-Containing Zinc-Based Alloyed Material

The particulate bismuth-containing zinc-based alloyed material (also referred to as in the claims as “a particulate zinc-based alloyed material”) is a crucial component of the coating composition.

Typically, the expression “zinc-based” is intended to mean that at least 95% by weight of the particulate alloyed material is zinc, e.g. at least 97%, such as at least 98%, by weight of the particulate alloyed material, the main unavoidable impurity typically being oxygen, which forms zinc oxide at the surface of the material.

Moreover, a minimum amount of bismuth has to be present in the alloy so as to ensure the required anti-corrosive effect when included in the coating composition.

In view of the conclusions drawn based on the current results, it appears that materials comprising 0.05-0.7% by weight of bismuth, more particular 0.1-0.6%, or 0.05-0.5% by weight of bismuth, are advantageous.

Moreover, the D₅₀ of the particulate material is preferably in the range of 2.5-30 μm, in particular 2.5-20 μm.

The term “particulate material” is intended to cover both fine spherical or somewhat irregularly shaped particles and other shapes such as flake, disc, spheres, needles, platelets, fibres and rods. A preferred particulate material is a powder.

When used in the present description and claims, the terms “particle size” and “particle diameter” are intended to mean the equivalent diameter.

Although 0.05% by weight of bismuth already leads to a measurable effect, it is preferred to use more than 0.1%, and even more preferred to use more than 0.15%. Although it is thermodynamically feasible to produce alloys with bismuth contents much higher than 0.7%, this may be technically difficult in practice, due to the high level of oxidation in the smelt. Alloys with less than 0.6% of bismuth are however more practicable and are appropriate in terms anti-corrosive properties. Alloys with less than 0.55% of bismuth are most preferred as they are even more easily prepared.

The alloy is preferably prepared from pure zinc, such as SHG (Super High Grade) zinc, and pure (99.99% or better) bismuth.

Alternatively, and apart from zinc and bismuth, the alloy may also contain pure (99.99% or better) aluminium up to a level of 0.2% by weight, such as up to a level of 0.1% by weight, preferably up to 0.01%. Aluminium is indeed known to impart enhanced anti-corrosion properties to zinc, such as white rust resistance. During the production of the particulate material (in particular a powder), aluminium could also retard the oxidation of the smelt.

In a further alternative, the alloy may, apart from zinc and bismuth, also contain (99.99% or better) one or more alloying trace elements up to a total level of 0.3% by weight, preferably up to a total level of 0.1% by weight, in particular up to a total level of 0.01% by weight. Such trace elements are preferably selected from the group consisting of aluminium, indium, magnesium, manganese, chromium, titanium, yttrium, cerium, lanthanum, tin, gallium, nickel, lead, cadmium, cobalt, iron and calcium.

The particle size distribution of the particulate material (in particular a powder) is of major importance in painting applications. For example too coarse particulate materials would result in particles sticking through the dry paint film. Therefore, it is highly preferred to use particulate materials with a D₅₀ (mean particle size) of less than 30 μm, in particular less than 20 μm. A D₅₀ of less than 15 μm is often more preferred, and less than 12 μm is even more preferred. The lower limit of the D₅₀ is dictated by economic considerations. At a D₅₀ of less than 2.5 μm, a too large fraction of the powder has to be sieved out and recycled for the complete process to run economically.

In addition to the remarks above, particles coarser than 100 μm should be avoided as much as possible, as they may stick out of the paint film. This would lead to defects in the paint film and deteriorate the barrier effect and the anti-corrosion properties. Therefore it is useful to discard, e.g. by sieving, any particles larger than 100 μm. In practice, a D₉₉ of less than 100 μm is deemed to be adequate.

It should be noted that the particle size distribution of the materials prepared according to the invention were measured using a Helos® Sympatec GmbH laser diffraction apparatus. The parameters D₅₀ and D₉₉ are equivalent particle diameters for which the volume cumulative distribution, Q3, assumes values of respectively 50 and 99%.

Additives can usefully be added to the zinc-based alloyed material. Preferably up to 30% by weight of additives are added to the zinc-based alloyed material. Additives comprise free flowing agents such as fumed silica, fillers such as MIO and BaSO₄, and conductive pigments such as Ferrophos®.

The particulate materials (in particular powders) can be manufactured by classic gas atomization of a corresponding alloy, e.g. a Zn—Bi alloy. As the particulate materials (in particular powders) directly obtained from such a process include coarse particles, which are incompatible with the envisaged application, a sieving or a classifying operation has to be performed. For example, sieving at 325 mesh or finer is typically needed to ensure a sieve residue at 45 μm lower than 0.1%. Reference is also made to the Examples section herein.

This being said, another aspect of the present invention relates to a particulate zinc-based alloyed material, wherein the material comprises 0.05-0.7% by weight of bismuth (Bi), and wherein the D₅₀ of the particulate material is in the range of 2.5-30 μm, in particular 2.5-20 μm.

Preferably, the material comprises more than 0.1%, and preferably more than 0.15%, by weight of bismuth. Also interesting are the materials which comprise less than 0.6%, and preferably less than 0.55%, by weight of bismuth.

With respect to the particle size, it is preferred that the D₅₀ of the particulate material is in the range of 2.5-15 μm, and preferably in the range of 2.5-12 μm. Additionally, the D₉₉ of the particulate material should preferably be less than 100 μm.

In one particularly interesting embodiment of the above the material consists of zinc, bismuth, and unavoidable impurities.

In another particularly interesting embodiment of the above, the material consists of zinc, bismuth, one or more alloying trace elements selected from the group consisting of aluminium, indium, magnesium, manganese, chromium, titanium, yttrium, cerium, lanthanum, tin, gallium, nickel, lead, cadmium, cobalt, iron and calcium up to a total level of 0.3% by weight (as mentioned above, such as up to 0.2% by weight, preferably up to 0.1% by weight and in particular up to 0.01% by weight), and unavoidable impurities.

In yet another particularly interesting embodiment of the above, the material consists of zinc, bismuth, up to 0.2% by weight, such as up 0.1% by weight of aluminium, and unavoidable impurities.

A further aspect of the present invention relates to a composite powder consisting of the particulate zinc-based alloyed material as defined above, and up to 30% by weight of one or more additives. Preferably, the one or more additives are selected from flowing agents, fillers, and conductive pigments.

A still further aspect of the invention relates to a composite powder consisting of at least 25% by weight of the particulate zinc-based alloyed material as defined herein, the rest being a particulate material consisting of zinc and unavoidable impurities.

With respect to the particle size, it is preferred that the D₅₀ of the composite powder is in the range of 2.5-30 μm, in particular 2.5-20 μm, and preferably below 15 μm, even more preferably below 12 μm. Additionally, the D₉₉ of the composite powder should preferably be less than 100 μm.

The materials and preferences for the particulate zinc-based alloyed materials described above are also preferences applicable for the materials used in the coating compositions of the invention. Hence, in some interesting embodiments, the particulate zinc-based alloyed material is as defined hereinabove, or is a composite powder as defined hereinabove.

### Zinc Powder

The coating composition may also comprise a particulate zinc material (e.g. a powder). The combined amount of the particulate zinc material and the particulate bismuth-containing zinc-based alloyed material (e.g. powder) should be 10-65% by solids volume of the paint.

Preferably, 25-100% by weight of the combined amount of the particulate zinc material (e.g. powder) and the particulate bismuth-containing zinc-based alloyed material (e.g. powder) is particulate bismuth-containing zinc-based alloyed material, such as 50-100% by weight.

### The Binder System

It should be understood that present invention in principle is applicable for any type of binder system in which zinc powder can be incorporated, e.g. anti-corrosive coating compositions of the conventional type. The most typical examples hereof are coating composition comprising a binder system selected from epoxy-based binder systems, silicate-based binder systems, polyurethane-based binder systems, cyclic rubber-based binder systems, and phenoxy resin-based binder systems.

### Epoxy-Based Binder System

In one particularly interesting embodiment, the binder system is an epoxy-based binder system.

The term “epoxy-based binder system” should be construed as the combination of the one or more epoxy resins, one or more curing agents, any reactive epoxy diluents and any reactive acrylic modifiers.

The epoxy-based binder system is one of the most important constituents of the paint composition, in particular with respect to the anticorrosive properties.

The epoxy-based binder system comprises one or more epoxy resins selected from aromatic or non-aromatic epoxy resins (e.g. hydrogenated epoxy resins), containing more than one epoxy group per molecule, which is placed internally, terminally, or on a cyclic structure, together with one or more suitable curing agents to act as cross-linking agents. Combinations with reactive diluents from the classes mono functional glycidyl ethers or esters of aliphatic, cycloaliphatic or aromatic compounds can be included in order to reduce viscosity and for improved application and physical properties.

Suitable epoxy-based binder systems are believed to include epoxy and modified epoxy resins selected from bisphenol A, bisphenol F, Novolac epoxies, non-aromatic epoxies, cycloaliphatic epoxies, epoxidised polysulfides, glycidyl esters and epoxy functional acrylics or any combinations hereof. Examples of suitable commercially available epoxy resins are:

Epikote 828, ex. Resolution Performance Products (The Netherlands), bisphenol A type
Araldite GY 250, ex. Huntsman Advanced Materials (Switzerland), bisphenol A type
Epikote 1004, ex. Resolution Performance Products (Germany), bisphenol A type
DER 664-20, ex. Dow Chemicals (Germany), bisphenol A type
Epikote 1001 X 75, ex. Resolution Performance Products (The Netherlands), bisphenol A type
Araldite GZ 7071X75BD, ex. Huntsman Advanced Materials (Germany), bisphenol A type
DER 352, ex. Dow Chemicals (Germany), mixture of bisphenol A and bisphenol F
Epikote 235, ex. Resolution Performance Products (The Netherlands), mixture of bisphenol A and bisphenol F
Epikote 862, ex. Resolution Performance Products (The Netherlands), bisphenol F type
DEN 438-X 80, ex. Dow Chemical Company (USA), epoxy novolac
Epikote 154, ex. Resolution Performance Products (The Netherlands), epoxy novolac

The epoxy-based binder system comprises one or more curing agents selected from compounds or polymers comprising at least two reactive hydrogen atoms linked to nitrogen.

Suitable curing agents are believed to include amines or amino functional polymers selected from aliphatic amines and polyamines (e.g. cycloaliphatic amines and polyamines), polyamidoamines, polyoxyalkylene amines (e.g. polyoxyalkylene diamines), aminated polyalkoxyethers (e.g. those sold commercially as “Jeffamines”), alkylene amines (e.g. alkylene diamines), aralkylamines, aromatic amines, Mannich bases (e.g. those sold commercially as “phenalkamines”), amino functional silicones or silanes, and including epoxy adducts and derivatives thereof.

Examples of suitable commercially available curing agents are:

Jeffamine EDR-148 ex. Huntsman Corporation (USA), triethyleneglycoldiamine
Jeffamine D-230 ex. Huntsman Corporation (USA), polyoxypropylene diamine
Jeffamine D-400 ex. Huntsman Corporation (USA), polyoxypropylene diamine
Jeffamine T-403 ex. Huntsman Corporation (USA), polyoxypropylene triamine
Ancamine 1693 ex. Air Products (USA), cycloaliphatic polyamine adduct
Ancamine X2280 ex. Air Products (USA), cycloaliphatic amine
Ancamine 2074 ex. Air Products (USA), cycloaliphatic polyamine adduct
Ancamide 350 A ex. Air Products (USA), polyaminoamide
Sunmide CX-105X, ex. Sanwa Chemical Ind. Co. Ltd. (Singapore), Mannich base
Epikure 3140 Curing Agent, ex. Resolution Performance Products (USA), polyamidoamine
SIQ Amin 2030, ex. SIQ Kunstharze GmbH (Germany), polyamidoamine
Epikure 3115X-70 Curing Agent, ex. Resolution Performance Products (USA), polyamidoamine
SIQ Amin 2015, ex. SIQ Kunstharze GmbH (Germany), polyamidoamine
Polypox VH 40309/12, ex. Ulf Prümmer Polymer-Chemie GmbH (Germany), polyoxyalkylene amine
CeTePox 1490H, ex. CTP Chemicals and Technologies for Polymers (Germany), polyoxyalkylene amine
Epoxy hardener MXDA, ex. Mitsubishi Gas Chemical Company Inc (USA), aralkyl amine
Diethylaminopropylamine, ex. BASF (Germany), aliphatic amine
Gaskamine 240, ex. Mitsubishi Gas Chemical Company Inc (USA), aralkyl amine
Cardolite Lite 2002, ex. Cardanol Chemicals (USA), Mannich base
Aradur 42 BD, ex. Huntsman Advanced Materials (Germany), cycloaliphatic amine
Isophorondiamin, ex. BASF (Germany), cycloaliphatic amine
Epikure 3090 Curing Agent, ex. Resolution Performance Products (USA), polyamidoamine adduct with epoxy
Crayamid E260 E90, ex. Cray Valley (Italy), polyamidoamine adduct with epoxy
Aradur 943 CH, ex. Huntsman Advanced Materials (Switzerland), alkylene amine adduct with epoxy
Aradur 863 XW 80 CH, ex. Huntsman Advanced Materials (Switzerland), aromatic amine adduct with epoxy
Cardolite NC-541, ex. Cardanol Chemicals (USA), Mannich base
Cardolite Lite 2001, ex. Cardanol Chemicals (USA), Mannich base

Preferred epoxy-based binder systems comprises a) one or more epoxy resins selected from bisphenol A, bisphenol F and Novolac; and b) one or more curing agents selected from Mannich Bases, polyamidoamines, polyoxyalkylene amines, alkylene amines, aralkylamines, polyamines, and adducts and derivatives thereof.

Preferably the epoxy resin has an epoxy equivalent weight of 100-2000, such as 100-1500 e.g. 150-1000 such as 150-700.

Especially preferred epoxy-based binder systems comprises one or more bisphenol A epoxy resins having an epoxy equivalent weight of 150-700 and one or more polyamidoamine or adducts and derivatives thereof.

Preferred epoxy-based binder systems are ambient curing binder systems.

In the paint composition, the total amount of epoxy-based binder system is in the range of 15-80%, such as 20-65% by solids volume of the paint.

Without being bound to any particular theory, it is believed that the selection of the ratio between the hydrogen equivalents of the one or more curing agents and the epoxy equivalents of the one or more epoxy resins plays a certain role for the performance of the coating composition.

When use herein, the term “hydrogen equivalents” is intended to cover only reactive hydrogen atoms linked to nitrogen.

The number of “hydrogen equivalents” in relation to the one or more curing agents is the sum of the contribution from each of the one or more curing agents. The contribution from each of the one or more curing agents to the hydrogen equivalents is defined as grams of the curing agent divided by the hydrogen equivalent weight of the curing agent, where the hydrogen equivalent weight of the curing agent is determined as: grams of the curing agent equivalent to 1 mol of active hydrogen. For adducts with epoxy resins the contribution of the reactants before adduction is used for the determination of the number of “hydrogen equivalents” in the epoxy-based binder system.

The number of “epoxy equivalents” in relation to the one or more epoxy resins is the sum of the contribution from each of the one or more epoxy resins. The contribution from each of the one or more epoxy resins to the epoxy equivalents is defined as grams of the epoxy resin divided by the epoxy equivalent weight of the epoxy resin, where the epoxy equivalent weight of the epoxy resin is determined as: grams of the epoxy resin equivalent to 1 mol of epoxy groups. For adducts with epoxy resins the contribution of the reactants before adductation is used for the determination of the number of “epoxy equivalents” in the epoxy-based binder system.

Preferably the ratio between the hydrogen equivalents of the one or more curing agents and the epoxy equivalents of the one or more epoxy resins is in the range of 20:100 to 120:100.

### Silicate-Based Binder System

In another embodiment, the binder system is a silicate-based binder system. The term “silicate-based binder system” should be construed as the combination of one or more silicate resins, any catalysts and any accelerators.

The silicate based binder system comprises one or more silicate resins selected from a group of silicate resins. Suitable silicate-based binder systems include ethyl silicates although other alkyl silicates, wherein the alkyl groups contained from 1 to 8 carbon atoms, such as methyl silicates, propyl silicates, butyl silicates, hexyl silicates and octyl silicates can also be employed, either alone or in admixture. The silicate used can be partly hydrolysed if needed.

Examples of suitable commercially available silicate resins are:

Dynasylan 40, ex. Degussa (Germany), ethyl silicate
Silikat TES 40 WN, ex. Wacker Chemie (Germany), ethyl silicate
Silbond 40, ex. Silbond Corporation (USA), ethyl silicate
Silikat TES 28, ex. Wacker Chemie (Germany), ethyl silicate
Tetra Methyl Orthosilicate, ex. Fuso Chemical Co., Ltd (Japan), methyl silicate
Tetra Normal Propyl Silicate, ex. Praxair Technology Incorporated, propyl silicate
Tetra Butyl Silicate, ex. Nantong Chengang Chemical Factory (China), butyl silicate

Ethyl silicate has been the dominant silicate binder for more than 30 years. Other alkyl types have been used such as isopropyl and butyl from which the corresponding alcohol is evolved on hydrolysis, but ethyl, despite of the low flash point of 10° C. of ethanol, is the principle type used. Ethanol is completely miscible with water, ideal for hydrolysis and has low toxicity. Curing speed is faster than with higher alcohols.

The silicate-based binder system comprises one or more catalysts. Suitable catalysts are believed to include hydrochloric acid and sulphuric acid.

A common way to reduce the curing time is to add an accelerator such as zinc chloride or magnesium chloride. The silicate-based binder system comprises one or more accelerators selected from zinc chloride, magnesium chloride or borate types like trimethylborate.

Examples of suitable commercially available accelerators are:

Zinc Chloride, ex. Barcelonesa de Droguas y Producto Químicos (Spain), anhydrous zinc chloride
Magnesium chloride (CAS no. 7786-30-3), ex Merck (Germany), anhydrous magnesium chloride
Silbond TMB 70, ex. Silbond Corporation (USA), trimethylborate

Alternatively, the binder system of the coating composition is selected from polyurethane-based binder systems, cyclic rubber-based binder systems, and phenoxy resin-based binder systems. Examples of such commercial coating compositions are of the type where zinc powder has conventionally been used.

### Other Constituents

The paint composition may comprise co-binders (e.g. plasticizers). Examples of co-binders (e.g. plasticizers) are hydrocarbon resins, phthalates and benzyl alcohol. In one preferred embodiment the paint composition comprises a hydrocarbon resin as co-binder (e.g. plasticizers).

The paint composition may comprise other paint constituents as will be apparent for the person skilled in the art. Examples of such paint constituents are pigments, fillers, additives (e.g. surfactants, wetting agents and dispersants, de-foaming agents, catalysts, stabilizers, corrosion inhibitors, coalescing agents, thixotropic agents (such as bentonites), anti-settling agents and dyes).

In the paint composition, the total amount of the particulate zinc material (e.g. powder), the particulate bismuth-containing zinc-based alloyed material (e.g. powder), any pigments and any fillers may be in the range of 1-70% by solids volume of the paint, such as 5-65% by solids volume of the paint, preferably 10-65% by solids volume of the paint.

It is envisaged that certain electrically conducting or corrosion inhibiting pigments, fillers and resins have a beneficial effect on the anticorrosive properties. Examples of such active pigments or fillers are aluminium pigments, zinc phosphate, black iron oxide, antimony-doped tin oxide, mica, carbon black, carbon black nano tubes, carbon black fibres, graphite and cement. In one preferred embodiment the paint composition comprises 0-15% by solids volume of the paint of active pigments or fillers, preferably 1-15% by solids volume of the paint, such as 1-10% by solids volume of the paint.

In the paint composition, the total amount of additives may be in the range of 0-10%, such as 0.1-8% by solids volume of the paint.

Preferably the paint composition comprises one or more additives selected from the group of wetting agents and dispersants. Wetting agents and dispersants helps in achieving a homogeneous dispersion of the particulate bismuth-containing zinc-based alloyed material (e.g. powder). Examples of suitable wetting agents and dispersants are:

Cargill Lecikote 20 ex. Cargill Foods (Belgium)
Lipotin 100 ex. Degussa Texturant Systems (Germany)
Nuosperse 657 ex. Elementis Specialities (The Netherlands)
Anti Terra U ex. BYK Chemie (Germany)
Disperbyk 164 ex. BYK Chemie (Germany)
Anti Terra 204 ex. BYK Chemie (Germany)

In case of epoxy-based binder systems, the paint composition may comprise epoxy accelerators. Examples are substituted phenols such as 2,4,6-tris (dimethylamino methyl) phenol, p-tert. Butylphenol, nonyl phenol etc.

The paint composition typically comprises a solvent or solvents. Examples of solvents are alcohols such as water, methanol, ethanol, propanol, isopropanol, butanol, isobutanol and benzyl alcohol; alcohol/water mixtures such as ethanol/water mixtures; aliphatic, cycloaliphatic and aromatic hydrocarbons such as white spirit, cyclohexane, toluene, xylene and naphtha solvent; ketones such as methyl ethyl ketone, acetone, methyl isobutyl ketone, methyl isoamyl ketone, diacetone alcohol and cyclohexanone; ether alcohols such as 2-butoxyethanol, propylene glycol monomethyl ether and butyl diglycol; esters such as methoxypropyl acetate, n-butyl acetate and 2-ethoxyethyl acetate; and mixtures thereof.

Depending on the application technique, it is desirable that the paint comprises solvent(s) so that the solids volume ratio (SVR—ratio between the volume of solid constituents to the total volume) is in the range of 30-100%, preferably 50-100%, in particular 55-100% e.g. 60-100%.

SVR is determined according to ISO 3233 or ASTM D 2697 with the modification that drying is carried out at 20° C. and 60% relative humidity for 7 days instead of drying at higher temperatures.

The coating composition of the present invention may be water-based. In one embodiment the zinc powder of an existing commercially available zinc epoxy coating composition is replaced with the particulate bismuth-containing zinc-based alloyed material.

### Preferred Embodiments

One particularly interesting embodiment is the one which comprises:

10-65% by solids volume of the particulate bismuth-containing zinc-based alloyed material;
20-65% by solids volume of an epoxy-based binder system; and
0-40% by solids volume of other non-volatile components; and
solvents in an amount of 30-100% relative to the total volume of the solids.

Another particularly interesting embodiment is the one which comprises:

10-80% by solids volume of the particulate bismuth-containing zinc-based alloyed material;
15-60% by solids volume of a silicate-based binder system; and
0-40% by solids volume of other non-volatile components; and solvents in an amount of 30-100% relative to the total volume of the solids.

### Coating Systems

The term “substrate” is intended to mean a solid material onto which the coating composition is applied. The substrate typically comprises a metal such as steel.

The term “applying” is used in its normal meaning within the paint industry. Thus, “applying” is conducted by means of any conventional means, e.g. by brush, by roller, by air-less spraying, by air-spray, by dipping, etc. The commercially most interesting way of “applying” the coating composition is by spraying. Spraying is effected by means of conventional spraying equipment known to the person skilled in the art. The coating is typically applied in a dry film thickness of 5-100 μm.

In a particular embodiment of the invention, an outer coating composition is subsequently applied onto said zinc-containing coat. The outer coating is typically of a coating composition selected from epoxy-based coating compositions, polyurethane-based coating compositions, acrylic-based coating compositions, polyurea-based coating composition, polysiloxane-based coating compositions and fluoro polymer-based coating compositions. Moreover, the outer coating is typically applied in a dry film thickness of 30-200 μm.

In a particular variant hereof, an intermediate coating composition is first subsequently applied onto said zinc-containing coat, whereafter the outer coating is applied onto the outer coat. The intermediate coating is typically of a coating composition selected from epoxy-based coating compositions, acrylic-based coating compositions, and polyurethane-based coating compositions. Moreover, the intermediate coating is typically applied in a dry film thickness of 50-200 μm.

Hence, the present invention also provides a coated structure comprising a metal structure having a first coating of the zinc-containing coating composition defined herein applied onto at least a part of the metal structure in a dry film thickness of 5-100 μm; and an outer coating applied onto said zinc-containing coating in a dry film thickness of 30-200 μm. Preferably, the outer coating is of a coating composition selected from epoxy-based coating compositions, polyurethane-based coating compositions, acrylic-based coating compositions, polyurea-based coating composition, polysiloxane-based coating compositions and fluoro polymer-based coating compositions.

In an interesting variant hereof, an intermediate coating has been applied onto said zinc-containing coating in a dry film thickness of 50-200 μm before application of the outer coating composition. Preferably, the intermediate coating is of a coating composition selected from epoxy-based coating compositions, acrylic-based coating compositions, and polyurethane-based coating compositions.

The structure is typically selected from fixed or floating offshore equipment, e.g. for the oil and gas industry such as oil rigs, bridges, containers, refineries, petrochemical industry, power-plants, storage tanks, cranes, windmills, steel structures part of civil structures e.g. airports, stadia and tall buildings.

The structure is of a metal, in particular steel.

### Preparation of the Paint Composition

The paint may be prepared by any suitable technique that is commonly used within the field of paint production. Thus, the various constituents may be mixed together using a high speed disperser, a ball mill, a pearl mill, a three-roll mill etc. The paints according to the invention may be filtrated using bag filters, patron filters, wire gap filters, wedge wire filters, metal edge filters, EGLM turnoclean filters (ex. Cuno), DELTA strain filters (ex. Cuno), and Jenag Strainer filters (ex. Jenag), or by vibration filtration.

The paint composition to be used in the method of the invention is prepared by mixing two or more components e.g. two pre-mixtures, one pre-mixture comprising the one or more epoxy resins and one pre-mixture comprising the one or more curing agents. It should be understood that when reference is made to the paint composition, it is the mixed paint composition ready to be applied. Furthermore all amounts stated as % by solids volume of the paint should be understood as % by solids volume of the mixed paint composition ready to be applied.

### EXAMPLES

### Preparation of Test Panels

Where not specifically stated elsewhere, the test panels used are applied according to the procedure stated below.

Steel panels are coated with 1×70 μm of the paint to be tested. The steel panels used are all cold rolled mild steel, abrasive blasted to Sa 3 (ISO 8501-1), with a surface profile equivalent to BN 9 (Rugotest No. 3). After the samples have been coated the panels are conditioned at a temperature of 23±2° C. and 50±5% relative humidity for a period of 21 days if not otherwise stated.

### Testing According to ISO 20340

The panels are exposed according to ISO 20340 Procedure A: Standard procedure with low-temperature exposure (thermal shock)

The exposure cycle used in this procedure lasts a full week (168 h) and includes 72 hours of QUV, 72 hours of Salt Spray test (SST) and 24 hours of thermal shock (−20° C.)
The QUV exposure is according to ISO 11507, accelerated weathering, by exposure to fluorescent ultraviolet (UV) light and condensation in order to simulate the deterioration caused by sunlight and water as rain or dew. QUV cycle: 4 hours UV-light at 60±3° C. with UVA-340 lamps and 4 hours condensation at 50±3° C.
The SST exposure is according to ISO 7253, exposure to constant spray with 5% NaCl solution at 35° C.
The thermal shock exposure consists of placing the panels in a freezer, at −20±2° C.

Total period of exposure: 25 cycles equal to 4200 hours.

Before the panels are started in the climatic cycle, they are given a 2 mm-wide score placed horizontally, 20 mm from the bottom and sides.

When the test is stopped, the paint film is removed from the score, and the width of the rusting is evaluated. After removing the coating by a suitable method, the width of the corrosion is measured at nine points (the midpoint of the scribe line and four other points, 5 mm apart, on each side of the midpoint). The rust creep M is calculated from the equation M=(C−W)/2, where C is the average of the nine width measurements and W is the original width of the scribe.

### Preparation of Bismuth-Alloyed Zinc Powder

400 kg of SHG (Super High Grade) zinc is heated together with 1.5 kg of bismuth in a melting furnace to a temperature of 500° C. The melted alloy is atomized in a vertical close-coupled gas atomizer at a rate of 200 kg/h and at a temperature of 525° C., using air at a pressure of 4.5 bar. About 0.1% of fumed silica, which is a free-flowing additive, is added in the collecting filter. 380 kg of alloyed powder is obtained, which is then sieved at 325 mesh. This results in 300 kg of fine powder according to the invention. The D₅₀ of this powder is 9 μm, and its D₉₉ is 50 μm. It contains 0.35% bismuth, taking into account some loss of bismuth in the skimmings of the smelt.

It appears that the zinc powder is stabilised during the production process as follows: during the atomization process, the liquid particle is “cooled” and a very thin zinc oxide layer is formed at the surface and covers the particle. This can happen as the production process takes place in air.

Other alloys with a bismuth-content of in the range of 0.25-0.50% by weight were also prepared following the procedure described above.

### Preparation of Epoxy-Based Test Paint

6878 gram of epoxy base was prepared in the following way:

The epoxy resin solution, the reactive epoxy diluent, wetting agent, thixotropic agent and 75% of the solvent was premixed on a high speed mixer equipped with an impeller disc (90 mm in diameter) in a 2.5 litre can for 15 minutes at 1000 rpm. 5800 grams of zinc powder was then added and mixed for about 15 minutes at 2000 rpm. The remaining 25% of solvent was then added.

Just before the application, the commercial curing agent was added and the paint composition was mixed to a homogenous mixture.

### Preparation of Silicate-Based Test Paint

1695 gram of the commercial silicate-based base component was pre-mixed in the can with a high speed mixer equipped with an impeller disc (90 mm in diameter) for 2 minutes at 1000 rpm.

Zinc powder (2644 grams for Model Paint J, 3207 grams for Model Paint K, and 3773 grams for comparative Example 3) was added to the base component and mixed for about 15 minutes at 2000 rpm.

### Composition of Test Paints

| | Model | | Model | | Model | | Model | | Comparative | |
|---|---|---|---|---|---|---|---|---|---|---|
| | paint A | | paint B | | paint C | | paint D | | Example 1 | |
| | % w/w | % vs | % w/w | % vs | % w/w | % vs | % w/w | % vs | % w/w | % vs |
| Component 1: | | | | | | | | | | |
| Epoxy functional | | | | | | | | | | |
| compound | | | | | | | | | | |
| Epoxy resin solution | 9.1 | 28.5 | 9.1 | 28.5 | 9.7 | 29.9 | 9.1 | 28.5 | 9.1 | 28.5 |
| (75% w/w in xylene, | | | | | | | | | | |
| epoxy eq. w. = 475) | | | | | | | | | | |
| Araldite GZ | | | | | | | | | | |
| 7071X75CH, ex. | | | | | | | | | | |
| Huntsman Advanced | | | | | | | | | | |
| Materials - Switzerland | | | | | | | | | | |
| Reactive epoxy diluent | 0.7 | 3.7 | 0.7 | 3.7 | 0.7 | 3.9 | 0.7 | 3.7 | 0.7 | 3.7 |
| Araldite DY-E/BD, ex. | | | | | | | | | | |
| Huntsman Advanced | | | | | | | | | | |
| Materials - Germany | | | | | | | | | | |
| Additives | | | | | | | | | | |
| Dispersing agent | 0.2 | 1.0 | 0.2 | 1.0 | 0.2 | 1.0 | 0.2 | 1.0 | 0.2 | 1.0 |
| Stablec UB, ex. Archer | | | | | | | | | | |
| Daniels Midland Co - | | | | | | | | | | |
| USA | | | | | | | | | | |
| Rheological agent | 1.0 | 2.8 | 1.0 | 2.8 | 1.1 | 3.0 | 1.0 | 2.8 | 1.0 | 2.8 |
| Bentone 34, ex. | | | | | | | | | | |
| Elementis Specialities - | | | | | | | | | | |
| USA | | | | | | | | | | |
| Pigments and fillers | | | | | | | | | | |
| Zinc alloy, 0.5% Bi, | 78.3 | 55.1 | | | | | | | | |
| D₅₀ = 3.8 μm, D₉₉ = 14 μm | | | | | | | | | | |
| Zinc alloy, 0.25% Bi, | | | 78.3 | 55.1 | | | | | | |
| D₅₀ = 3.7 μm, D₉₉ = 14 μm | | | | | | | | | | |
| Zinc alloy, 0.25% Bi, | | | | | 76.7 | 52.8 | 39.1 | 27.5 | | |
| D₅₀ = 6.3 μm, D₉₉ = 27 μm | | | | | | | | | | |
| Zinc powder, Zinc | | | | | | | 39.1 | 27.5 | 78.2 | 55.1 |
| Powder Super Extra, | | | | | | | | | | |
| Umicore | | | | | | | | | | |
| D₅₀ = 3.8 μm, D₉₉ = 10 μm | | | | | | | | | | |
| Solvents | | | | | | | | | | |
| Xylene | 2.8 | 0 | 2.8 | 0 | 3.0 | 0 | 2.8 | 0 | 2.8 | 0 |
| Butanol | 1.1 | 0 | 1.0 | 0 | 1.1 | 0 | 1.1 | 0 | 1.0 | 0 |
| Total component 1: | 93.2 | 91.1 | 93.1 | 91.1 | 92.5 | 90.6 | 93.1 | 91.0 | 93.0 | 91.1 |
| Component 2: | | | | | | | | | | |
| Hempel curing agent | 6.8 | 8.9 | 6.9 | 8.9 | 7.5 | 9.4 | 6.9 | 9.0 | 7.0 | 8.9 |
| 98382-00000, ex. | | | | | | | | | | |
| Hempel - Denmark | | | | | | | | | | |
| Total component 2: | 6.8 | 8.9 | 6.9 | 8.9 | 7.5 | 9.4 | 6.9 | 9.0 | 7.0 | 8.9 |
| Total component 1 | 100 | 100 | 100 | 100 | 100 | 100 | 100 | 100 | 100 | 100 |
| and 2: | | | | | | | | | | |

| | | | | | |
|---|---|---|---|---|---|
| PVC % | 58 | 58 | 56 | 58 | 58 |
| SVR % | 60 | 60 | 59 | 60 | 60 |
| % by volume solids of | 55 | 55 | 53 | 55 | 55 |
| zinc powder, Bismuth- | | | | | |
| alloyed zinc powder, | | | | | |
| pigments and fillers. | | | | | |

| | Model paint E | | Model paint F | | Model paint G | |
|---|---|---|---|---|---|---|
| | % w/w | % vs | % w/w | % vs | % w/w | % vs |
| Component 1: | | | | | | |
| Epoxy functional compound | | | | | | |
| Epoxy resin solution (75% w/w in xylene, | 9.1 | 28.2 | 9.1 | 28.2 | 9.1 | 28.2 |
| epoxy eq. w. = 475) | | | | | | |
| Araldite GZ 7071X75CH, ex. Huntsman | | | | | | |
| Advanced Materials - Switzerland | | | | | | |
| Reactive epoxy diluent | 0.7 | 3.7 | 0.7 | 3.7 | 0.7 | 3.7 |
| Araldite DY-E/BD, ex. Huntsman Advanced | | | | | | |
| Materials - Germany | | | | | | |
| Additives | | | | | | |
| Dispersing agent | 0.2 | 1.0 | 0.2 | 1.0 | 0.2 | 1.0 |
| Stablec UB, ex. Archer Daniels Midland Co - | | | | | | |
| USA | | | | | | |
| Rheological agent | 1.0 | 3.0 | 1.0 | 3.0 | 1.0 | 3.0 |
| Bentone 34, ex. Elementis Specialities - USA | | | | | | |
| Pigments and fillers | | | | | | |
| Zinc alloy, 0.05% Bi, | 78.3 | 54.7 | | | | |
| D₅₀ = 3.7 μm, D₉₉ = 15 μm | | | | | | |
| Zinc alloy, 0.10% Bi, | | | 78.3 | 54.7 | | |
| D₅₀ = 3.7 μm, D₉₉ = 14 μm | | | | | | |
| Zinc alloy, 0.25% Bi, | | | | | 78.3 | 54.7 |
| D₅₀ = 3.8 μm, D₉₉ = 15 μm | | | | | | |
| Zinc alloy, 0.40% Bi, | | | | | | |
| D₅₀ = 4.0 μm, D₉₉ = 16 μm | | | | | | |
| Zinc alloy, 0.50% Bi, | | | | | | |
| D₅₀ = 3.9 μm, D₉₉ = 16 μm | | | | | | |
| Zinc powder, Zinc Powder Super Extra, | | | | | | |
| Umicore | | | | | | |
| D₅₀ = 4.4 μm, D₉₉ = 27 μm | | | | | | |
| Solvents | | | | | | |
| Xylene | 2.2 | 0 | 2.2 | 0 | 2.2 | 0 |
| Butanol | 1.1 | 0 | 1.1 | 0 | 1.1 | 0 |
| Total component 1: | 92.6 | 90.6 | 92.6 | 90.6 | 92.6 | 90.6 |
| Component 2: | | | | | | |
| Hempel curing agent 98382-00000, ex. | 7.4 | 9.4 | 7.4 | 9.4 | 7.4 | 9.4 |
| Hempel - Denmark | | | | | | |
| Total component 2: | | | | | | |
| Total component 1 and 2: | 100 | 100 | 100 | 100 | 100 | 100 |
| PVC % | 58 | | 58 | | 58 | |
| SVR % | 61 | | 61 | | 61 | |
| % by volume solids of zinc powder, Bismuth- | 55 | | 55 | | 55 | |
| alloyed zinc powder, pigments and fillers. | | | | | | |
| | | | | | Comparative | |
| | Model paint H | | Model paint I | | Example 2 | |
| | % w/w | % vs | % w/w | % vs | % w/w | % vs |
| Component 1: | | | | | | |
| Epoxy functional compound | | | | | | |
| Epoxy resin solution (75% w/w in xylene, | 9.1 | 28.2 | 9.1 | 28.2 | 9.1 | 28.2 |
| epoxy eq. w. = 475) | | | | | | |
| Araldite GZ 7071X75CH, ex. Huntsman | | | | | | |
| Advanced Materials - Switzerland | | | | | | |
| Reactive epoxy diluent | 0.7 | 3.7 | 0.7 | 3.7 | 0.7 | 3.7 |
| Araldite DY-E/BD, ex. Huntsman Advanced | | | | | | |
| Materials - Germany | | | | | | |
| Additives | | | | | | |
| Dispersing agent | 0.2 | 1.0 | 0.2 | 1.0 | 0.2 | 1.0 |
| Stablec UB, ex. Archer Daniels Midland Co - | | | | | | |
| USA | | | | | | |
| Rheological agent | 1.0 | 3.0 | 1.0 | 3.0 | 1.0 | 3.0 |
| Bentone 34, ex. Elementis Specialities - USA | | | | | | |
| Pigments and fillers | | | | | | |
| Zinc alloy, 0.05% Bi, | | | | | | |
| D₅₀ = 3.7 μm, D₉₉ = 15 μm | | | | | | |
| Zinc alloy, 0.10% Bi, | | | | | | |
| D₅₀ = 3.7 μm, D₉₉ = 14 μm | | | | | | |
| Zinc alloy, 0.25% Bi, | | | | | | |
| D₅₀ = 3.8 μm, D₉₉ = 15 μm | | | | | | |
| Zinc alloy, 0.40% Bi, | 78.3 | 54.7 | | | | |
| D₅₀ = 4.0 μm, D₉₉ = 16 μm | | | | | | |
| Zinc alloy, 0.50% Bi, | | | 78.3 | 54.7 | | |
| D₅₀ = 3.9 μm, D₉₉ = 16 μm | | | | | | |
| Zinc powder, Zinc Powder Super Extra, | | | | | 78.3 | 54.7 |
| Umicore | | | | | | |
| D₅₀ = 4.4 μm, D₉₉ = 27 μm | | | | | | |
| Solvents | | | | | | |
| Xylene | 2.2 | 0 | 2.2 | 0 | 2.2 | 0 |
| Butanol | 1.1 | 0 | 1.1 | 0 | 1.1 | 0 |
| Total component 1: | 92.6 | 90.6 | 92.6 | 90.6 | 92.6 | 90.6 |
| Component 2: | | | | | | |
| Hempel curing agent 98382-00000, ex. | 7.4 | 9.4 | 7.4 | 9.4 | 7.4 | 9.4 |
| Hempel - Denmark | | | | | | |
| Total component 2: | | | | | | |
| Total component 1 and 2: | 100 | 100 | 100 | 100 | 100 | 100 |
| PVC % | 58 | | 58 | | 58 | |
| SVR % | 61 | | 61 | | 61 | |
| % by volume solids of zinc powder, Bismuth- | 55 | | 55 | | 55 | |
| alloyed zinc powder, pigments and fillers. | | | | | | |
| | | | | | Comparative | |
| | Model paint J | | Model paint K | | Example 3 | |
| | % w/w | % vs | % w/w | % vs | % w/w | % vs |
| Component 1: | | | | | | |
| Hempel Galvosil base 15709-19840, ex. | 39.1 | 40.4 | 34.6 | 35.8 | 31.0 | 32.1 |
| Hempel - Denmark | | | | | | |
| Total component 1: | 39.1 | 40.4 | 34.6 | 35.8 | 31.0 | 32.1 |
| Component 2: | | | | | | |
| Zinc alloy, 0.40% Bi, | 60.9 | 59.6 | 65.4 | 64.2 | | |
| D₅₀ = 6.4 μm, D₉₉ = 29 μm | | | | | | |
| Zinc powder, Zinc Powder Super Extra, | | | | | 69.0 | 67.9 |
| Umicore | | | | | | |
| D₅₀ = 3.8 μm, D₉₉ = 10 μm | | | | | | |
| Total component 2: | 60.9 | 59.6 | 65.4 | 64.2 | 69.0 | 67.9 |
| Total component 1 and 2: | 100 | 100 | 100 | 100 | 100 | 100 |

| | | | |
|---|---|---|---|
| PVC % | 88.3 | 89.6 | 90.7 |
| SVR % | 33.3 | 36.0 | 38.5 |
| % by volume solids of zinc powder, Bismuth- | 59.6 | 64.2 | 67.9 |
| alloyed zinc powder, pigments and fillers. | | | |

In the above tables, “% w/w” means % weight of the wet weight, and “% vs” means % volume of the volume solids.

### Results

### Results of Rust Creep M

| Paint Composition | Relative rust creep* |
|---|---|
| Model paint A | 45 |
| Model paint B | 63 |
| Model paint C | 56 |
| Model paint D | 75 |
| Comparative Example 1 | 100 |

*Rust creep relative to Comparative Example 1. The lower the relative rust creep the better the performance.

| Paint Composition | Bismuth content [%] | Relative rust creep* |
|---|---|---|
| Model paint E | 0.05 | 86 |
| Model paint F | 0.10 | 62 |
| Model paint G | 0.25 | 38 |
| Model paint H | 0.40 | 22 |
| Model paint I | 0.50 | 38 |
| Comparative Example 2 | 0 | 100 |

*Rust creep relative to Comparative Example 2. The lower the relative rust creep the better the performance.

| Paint Composition | Bismuth content [%] | Relative rust creep* |
|---|---|---|
| Model paint J | 0.4 | 73 |
| Model paint K | 0.4 | 30 |
| Comparative Example 3 | 0 | 100 |

*Rust creep relative to Comparative Example 3. The lower the relative rust creep the better the performance.

We can conclude from the above table that Model Paints A to I show a significant improvement in rust creep compared to Comparative Examples 1 and 2, respectively.

It can also be concluded, that it is possible to obtain better rust creep results in silicate-based binder systems with reduced zinc amount, using the bismuth containing zinc alloy, compared to the Comparative Example 3 as shown with Model Paints J and K and Comparative Example 3.

1. A coating composition comprising a particulate zinc-based alloyed material, said material consisting of 0.1-0.7% by weight of bismuth (Bi), optionally one or more alloying trace elements up to a total level of 0.3% by weight, and the balance of zinc, the D₅₀ of the particulate material being in the range of 2.5-30 μm.

2. The coating composition according to claim 1, which comprises a binder system selected from epoxy-based binder systems, silicate-based binder systems, polyurethane-based binder systems, cyclic rubber-based binder systems, and phenoxy resin-based binder systems.

3. The coating composition according to claim 1, wherein the binder system is selected from an epoxy-based binder system and a silicate-based binder system.

4. The coating composition according to claim 1, wherein the binder system is an epoxy-based binder system.

5. The coating composition according to claim 1, wherein the particulate zinc-based alloyed material is as defined in claim 11, or is a composite powder as defined in claim 19.

6. The coating composition according to claim 1, which comprises:
10-65% by solids volume of the particulate bismuth-containing zinc-based alloyed material;
20-65% by solids volume of an epoxy-based binder system; and
0-40% by solids volume of other non-volatile components; and
solvents in an amount of 30-100% relative to the total volume of the solids.

7. A coated structure comprising a metal structure having a first coating of the zinc-containing
coating composition defined in any one of the claims 1-4 applied onto at least a part of the metal structure in a dry film thickness of 5-100 μm; and an outer coating applied onto said zinc-containing coating in a dry film thickness of 30-200 μm.

8. The coated structure according to claim 7, wherein an intermediate coating has been applied onto said zinc-containing coating in a dry film thickness of 50-200 μm before application of the outer coating composition.

9. The coated structure according to claim 8, wherein the alloy contains pure (99.99% or better) aluminium up to a level of 0.1% by weight.

10. A particulate zinc-based alloyed material, wherein the material consists of 0.1-0.7% by weight of bismuth (Bi), optionally one or more alloying trace elements up to a total level of 0.3% by weight, and the balance of zinc, and wherein the D₅₀ of the particulate material is in the range of 2.5-30 μm.

11. The material according to claim 10, which comprises more than 0.1% by weight of bismuth.

12. The material according to claim 11, which comprises less than 0.6% by weight of bismuth.

13. The material according to claim 10, wherein the D₅₀ of the particulate material is in the range of 2.5-20 μm.

14. The material according to claim 10, wherein the D₉₉ of the particulate material is less than 100 μm.

15. The material according to claim 10, wherein the material consists of zinc, bismuth, one or more alloying trace elements selected from the group consisting of aluminium, indium, magnesium, manganese, chromium, titanium, yttrium, cerium, lanthanum, tin, gallium, nickel, lead, cadmium, cobalt, iron and calcium up to a total level of 0.3% by weight, and unavoidable impurities.

16. The material according to claim 10, wherein the material consists of zinc, bismuth, up to 0.2% by weight of aluminium, and unavoidable impurities.

17. The material according to claim 16, wherein the alloy consists of zinc, bismuth, up to 0.1% by weight of aluminium, and unavoidable impurities.

18. The material according to claim 10, wherein the material consists of zinc, bismuth, and unavoidable impurities.

19. A composite powder consisting of a particulate zinc-based alloyed material according to claim 10 and up to 30% by weight of one or more additives.

20. A composite powder consisting of at least 25% by weight of a particulate zinc-based alloyed material according to claim 10, the rest being a particulate material consisting of zinc and unavoidable impurities.
